(19) United States
(12) Patent Application Publication
(10) Pub. No.: US 2004/0164501 A1
(43) Pub. Date: Aug. 26, 2004

(54) Chuck for liquid-flushed working percussion tool

(76) Inventor: Stefan Gotzfried, Kleinkitzighofen (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/728,256

(22) Filed: Dec. 4, 2003

(30) Foreign Application Priority Data
Dec. 10, 2002 (DE) 102 57 483.9

(51) Int. Cl. B23B 31/00

(52) U.S. Cl. 279/20

(57) ABSTRACT

A pot-shaped chuck, which is designed to cooperate with a percussion mechanism (2) of a percussion power tool (3) and an empty space of which is open at a working tool side of the chuck for receiving a working percussion tool (5), includes guide elements (4) coaxial with a percussion axis (A) and in which the working tool (5) is received for joint rotation with the chuck (1) and for a limited axial displacement relative thereto, and a flushing liquid conduit (6) extending along an inner surface (7) forming the pot empty space of the chuck (1).

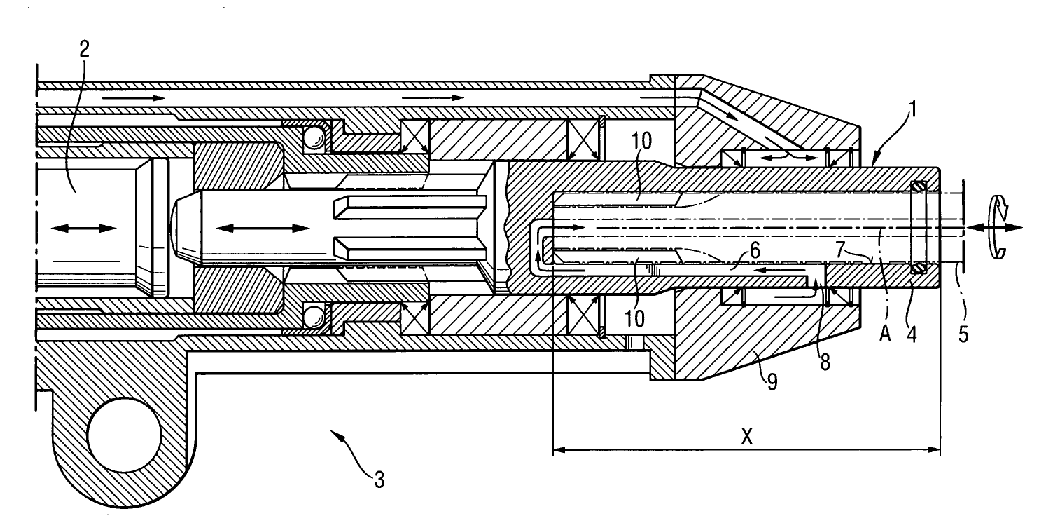

### BACKGROUND OF THE INVENTION

1. Field of the Invention

The present invention relates to a chuck for a liquid-flushed working percussion tool such as, e.g., a crushing chisel and a percussion drill for forming shot holes.

2. Description of the Prior Art

Chucks for working rotary percussion tools includes guide means coaxial with the percussion axis and in which a working tool is received for joint rotation with the chuck and for limited axial displacement relative thereto. The working tool is secured in entraining means of the chuck with appropriate locking means. A flush bore, which extends through working tool shank, has its mouth opening provided in the rower tool-side end surface of the shank which is subjected to blow pulses which are transmitted to the end surface from a pneumatic or electropneumatic percussion mechanism by an anvil. The resulting hydrostatic pressure pulses in the flushing liquid can be transmitted, in the absence of proper seating, along the anvil and can, thus, penetrate in the percussion mechanism, reducing its service life.

German Publication DE-886 434 and U.S. Pat. No. 5,346,023 both disclose a chuck for a working rotary percussion tool and having guide means coaxial with the percussion axis in which a working tool is received for joint rotation with the chuck and for a limited axial displacement relative thereto. The working tool is secured in entraining means with locking means. The chuck is formed as a pot-shaped member and is received in the percussion mechanism. With the bottom of the pot-shaped chuck completely closing the end surface of the working tool shank, the introduction of the flushing liquid through the end surface is not possible.

German Publication DE-41 31 070 discloses a pot-shaped chuck that is directly impacted by a hydraulic, flushing medium driven, percussion mechanism, and a bottom of which closes the end surface of a working tool which is received in the chuck. The chuck has a coaxial flushing medium conduit that forms part of a conduit extending through the entire percussion mechanism. This solution is applicable only for chucks used with hydraulic percussion mechanisms driven by a flushing medium.

Accordingly, an object of the present invention is to provide a chuck for a liquid-flushed, working percussion tool and with which, penetration of the flushing liquid in the percussion mechanism is prevented.

### SUMMARY OF THE INVENTION

This and other objects of the present invention, which will become apparent hereinafter, are achieved by providing a pot-shaped chuck designed to cooperate with a percussion mechanism of a percussion tool and an empty space of which is open at its working tool side for receiving working tool. The chuck includes guide means coaxial with a percussion axis and in which the working tool is received for joint rotation with the chuck and for a limited axial displacement relative thereto, and at least one flushing liquid conduit extending along an inner surface forming the pot empty space.

Through the flushing liquid conduit, the flushing liquid enters into the pot-shaped chuck, the power tool side of which is completely closed, and is introduced into the working percussion tool through an opening formed in its end surface, without a possibility of the flushing liquid to enter along the chuck into the percussion mechanism as a result of hydrostatic pressure pulses.

Advantageously, the flushing liquid conduit is formed as a groove in the inner surface of the pot-shaped chuck. Advantageously a flushing head is arranged radially outwardly rotation-free and liquid-tight in an axial region of a pot wall, with at least one cross-bore formed in the pot wall of the chuck and communicating the flushing head with the flushing liquid conduit. Thereby the flushing liquid is directly introduced into the working tool.

Advantageously entraining webs, which form entraining means for receiving a shank of the working tool, extend along the guide means. Alternatively, the entraining means can be formed as an inner thread that cooperates with an outer thread provided on the shank. In both cases, a high torque can be transmitted to the working tool.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

Single FIGURE of the drawings shows a cross-sectional view of a chuck according to the present invention for a liquid-flushed working percussion tool.

### DETAILED DESCRIPTION OF THE PREFERRED EMBODIMENT

A chuck 1 according to the present invention is associated with a percussion mechanism 2 of a percussion power tool 3 which is shown only partially. The chuck 1 is formed as a pot-shaped member with the empty space facing in the operational direction of the working percussion tool which is received in the chuck 1 The chuck 1 includes guide means 4 coaxial with the percussion axis A. A percussion tool, e.g., a percussion drill 5 is received within the guide means 4 for joint rotation with the chuck and for a limited axial displacement relative thereto. A flushing liquid conduit 6 is formed as a groove 6 extending along an inner surface which forms the pot-shaped space. In the axial region X of the pot wall, radially outwardly of the chuck 1, a flushing head 9 is provided. The flushing head 9 is arranged on the chuck 1 liquid-tight and does not rotate with the chuck 1. The flushing head 9 communicates with the groove 6 through cross-bores 8 formed in the pot wall. In the chuck 1, along the guide means 4, there are formed entraining webs that form entraining means 10 for receiving the shank of the percussion drill.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A pot-shaped chuck designed to cooperate with a percussion mechanism (2) of a percussion power tool (3) and an empty space of which is open at a working tool side thereof for receiving a working percussion tool (5), the chuck comprising guide means (4) coaxial with a percussion axis (A) and in which the working percussion tool (5) is received for joint rotation with the chuck (1) and for a limited axial displacement relative thereto; and at least one flushing liquid conduit (6) extending along an inner surface (7) forming the pot empty space.

2. A pot-shaped chuck according to claim 1, wherein the at least one flushing liquid conduit (6) is formed as a groove in the inner surface (7).

3. A pot-shaped chuck according to claim 1, further comprising a flushing head (9) arranged radially outwardly rotation-free and liquid-tightly in an axial region (X) of the pot wall; and at least one cross-bore (8) formed in the pot wall for communicating the flushing head (9) with the flushing liquid conduit (6).

4. A pot-shaped chuck according to claim 1, further comprising entraining webs extending along the guide means and forming entraining means (10) for receiving a shank of the working percussion tool (5) and for transmitting a torque to the working percussion tool.

5. A pot-shaped chuck according to claim 1, wherein the chuck has an inner thread extending along the guide means and cooperating with an outer thread provided on the shank for transmitting a torque thereto.
